(19) United States
(12) Patent Application Publication
(10) Pub. No.: US 2002/0062678 A1
(43) Pub. Date: May 30, 2002

(54) Fine friction and wear testing apparatus

(76) Inventors: Hyo Sok Ahn, Seoul-si (KR); Choong Hyun Kim, Seoul-si (KR); Sergei A. Chizhik, Belarus (RU); Oleg Y. Komkov, Belarus (RU); Andrei M. Dubravin, Belarus (RU)

Correspondence Address: BIRCH STEWART KOLASCH & BIRCH, PO BOX 747, FALLS CHURCH, VA, 22040-0747, US

(21) Appl. No.: 09/853,763

(22) Filed: May 14, 2001

(30) Foreign Application Priority Data
Nov. 28, 2000 (KR) 2000-71287

(51) Int. Cl. G01N 19/02; G01N 3/56

(52) U.S. Cl. 73/9

(57) ABSTRACT

Disclosed herein is a fine friction and wear testing apparatus. The fine friction and wear testing apparatus includes a working table to whose upper surface a plate specimen is secured. First drive means horizontally reciprocates the working table. A support arm is situated over the working table and securely holds a roundly tipped specimen to be projected downwardly. First sensing means senses the horizontal displacement of the plate specimen. Second drive means operates the support arm to exert a load on the plate specimen through the roundly tipped specimen. Second sensing means senses the displacement of the roundly tipped specimen. A control unit operates the first and second drive means in accordance with set values and calculates the displacements sensed by the first and second sensing means. A display shows the friction and wear characteristics of the specimens to users in real time.

### BACKGROUND OF THE INVENTION

1. Field of the Invention

The present invention relates generally to a fine friction and wear testing apparatus for investigating the fine friction and wear characteristics of a minute part that is employed in a miniaturized mechanical apparatus, and more particularly to a fine friction and wear testing apparatus, which is capable of investigating the friction and wear characteristics of a minute part in real time while controlling an applied load within a range of 0.03 to 2 N using magnetic force generated by the application of current to a winding and adjusting a slide speed within a range of 0.1 to 10 mm/s using a step motor control circuit in which friction and wear characteristics can be analyzed.

2. Description of the Prior Art

As mechanical and electronic technologies are rapidly developed, there is a trend in which a variety of apparatus are miniaturized and lightened. Accordingly, a need for the study of the friction and wear characteristics of the minute parts constituting the apparatus is increased for design and manufacture of the parts. For the purpose of studying the fine friction and wear characteristics, there is required the development of a precise testing apparatus in which a load exerted on a specimen is less than 1 N and the moving distance of the specimen is shorter than 1 mm.

A conventional friction and wear testing apparatus is generally operated under the test conditions of a high load greater than 10 N and a minimum reciprocating stroke greater than 10 mm. Accordingly, the conventional friction and wear testing apparatus is used to investigate the friction and wear characteristics of a general material. The conventional friction and wear testing apparatus imposes a load and a slide speed on a specimen in a relatively great range, so the testing apparatus cannot investigate the friction and wear characteristics of minute parts that are usually operated under the conditions of a low load and a low slide speed.

In addition, the conventional friction measuring apparatus is mounted on a specimen table, so that the movement of the table on which the apparatus is mounted affects a measuring sensor, and the measuring apparatus is affected by the variation in dynamic characteristics by the weight of a specimen, thereby increasing measurement errors.

### SUMMARY OF THE INVENTION

Accordingly, the present invention has been made keeping in mind the above problems occurring in the prior art, and an object of the present invention is to provide a fine friction and wear testing apparatus, which is capable of precisely testing the friction and wear characteristics of specimens by applying a load less than 0.01 N to a pair of specimens using magnetic force generating means that generates magnetic force by current applied to a winding and precisely controlling the reciprocating distance of specimens within 1 μm or less using a step motor.

In order to accomplish the above object, the present invention provides a fine friction and wear testing apparatus, comprising a working table to whose upper surface a plate specimen is secured, first drive means for horizontally reciprocating the working table, a support arm situated over the working table for securely holding a roundly tipped specimen to be projected downwardly, first sensing means for sensing the horizontal displacement of the plate specimen, second drive means for operating the support arm to exert a load on the plate specimen through the roundly tipped specimen, second sensing means for sensing the displacement of the roundly tipped specimen, a control unit for operating the first and second drive means in accordance with set values and calculating the displacements sensed by the first and second sensing means, and a display for showing the friction and wear characteristics of the specimens to users in real time.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a partially sectioned view showing a fine friction and wear testing apparatus in accordance with the present invention;

FIG. 2 is a perspective view of the fine friction and wear testing apparatus;

FIG. 3 is a block diagram showing the control unit of the fine friction and wear testing apparatus;

FIG. 4 is a block diagram showing a step motor control system employed in the fine friction and wear testing apparatus;

FIG. 5 is a view showing the operation of load-controlling and measuring means in accordance with the present invention;

FIG. 6 is a view showing the operation of frictional force measuring means in accordance with the present invention;

FIG. 7 is a diagram showing a method for measuring the shape of a friction surface in accordance with the present invention;

FIG. 8a is a plan view showing a guide employed in the friction and wear testing apparatus;

FIG. 8b is a view showing the operation of the guide of FIG. 8a;

FIG. 9 is a graph showing the load characteristics of the fine friction and wear testing apparatus; and

FIG. 10 is a graph showing the frequency characteristic of the first drive means of the fine friction and wear testing apparatus.

### DESCRIPTION OF THE PREFERRED EMBODIMENTS

Reference now should be made to the drawings, in which the same reference numerals are used throughout the different drawings to designate the same or similar components.

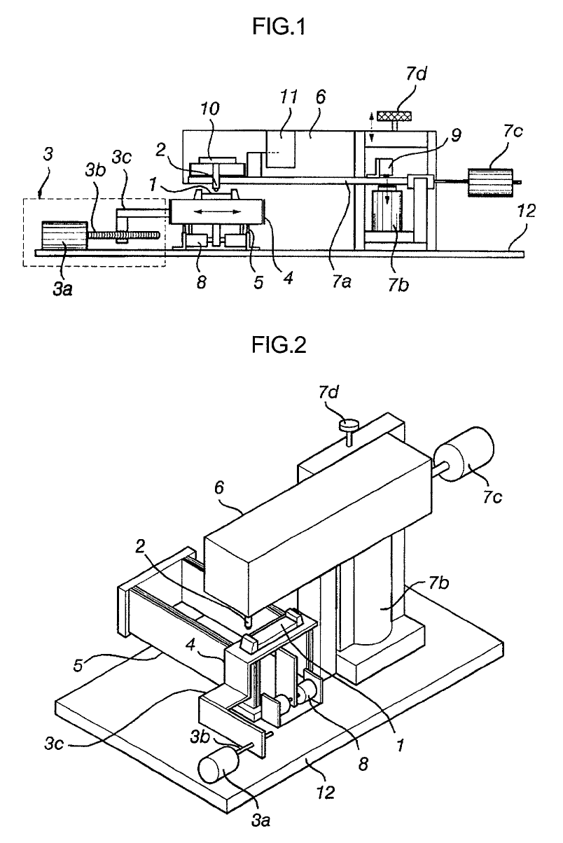

As depicted in FIGS. 1 and 2, a fine friction and wear testing apparatus of the present invention includes a working table 4 to whose upper surface a plate specimen 1 is secured. First drive means 3 is provided to horizontally reciprocate the working table 4 within a predetermined range. A support arm 6 is situated over the working table 4 and securely holds a roundly tipped specimen 2 to be projected downwardly. A first sensor 8 is provided to sense the horizontal displacement of the plate specimen 1. Second drive means operates the support arm 6 so as to exert a predetermined load on the plate specimen 1 by the roundly tipped specimen 2. A second sensor 9 is provided to sense an applied load exerted on the roundly tipped specimen 2. A third sensor 10 is provided to sense the horizontal displacement of the roundly tipped specimen. A fourth sensor 11 is provided to sense the horizontal displacement of the roundly tipped specimen 2. A control unit 200 controls the moving speeds and loads of the drive means utilizing the displacements and loads sensed by the sensors 8, 9, 10 and 11. A display 20 shows the friction and wear characteristics of the specimens 1 and 2 to users in real time. In such cases, induced electromotive force sensors, which generate electromotive force depending on displacements, can be employed as the sensors.

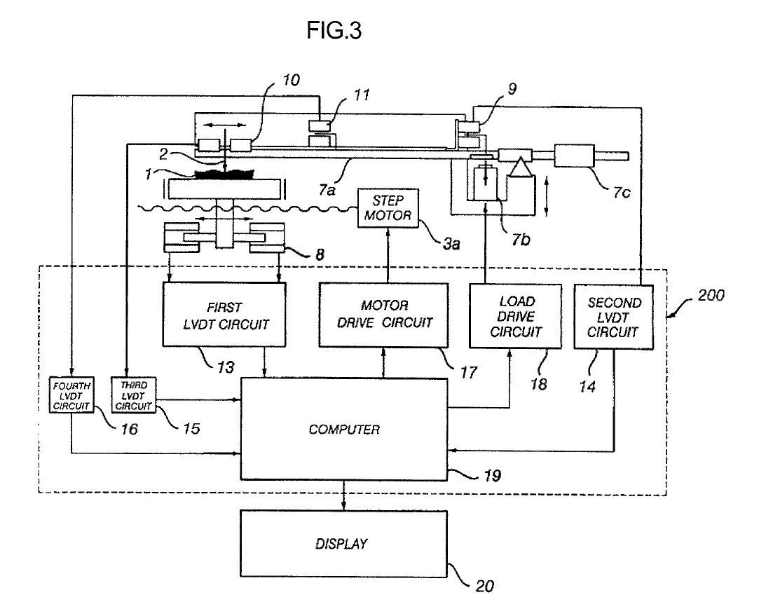

As illustrated in FIG. 3, the control unit 200 is comprised of first, second, third and fourth Linear Variable Differential Transformer (LVDT) circuits 13, 14, 15 and 16 and calculating means. The first, second, third and fourth LVDT circuits 13, 14, 15 and 16 serve to convert electromotive force generated in the first, second, third and fourth sensors 8, 9, 10 and 11 to analog signals, and the calculating means serves to calculate test values using signals output from the first and second LVDT circuits 13 and 14, transmit operation signals to a motor drive circuit 17 and a load drive circuit 18 and measure and calculate signals output from the third and fourth LDVT circuits 13 and 14. A computer 19 can be employed as the calculating means.

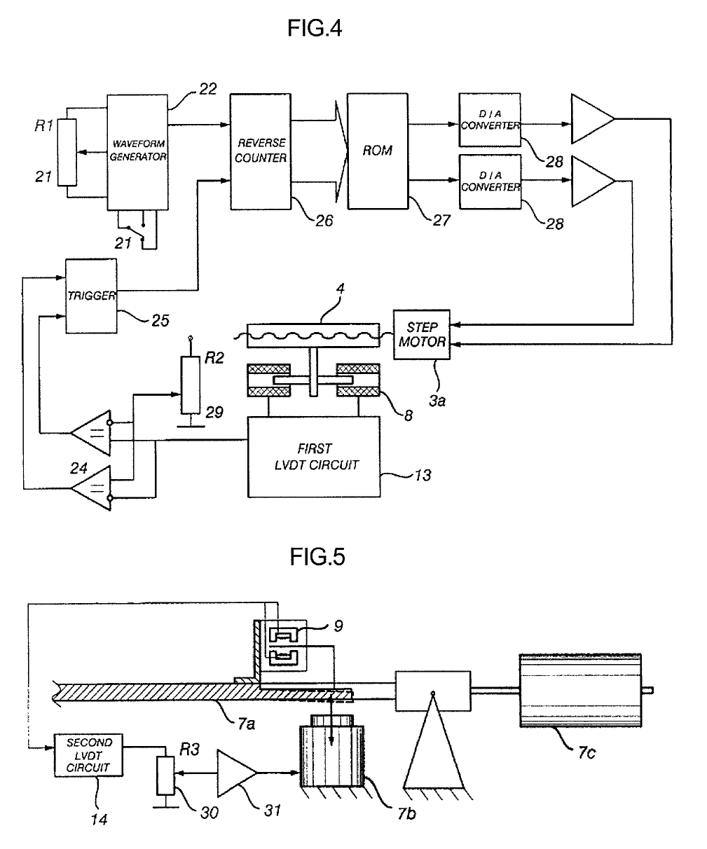

As shown in FIG. 4, the motor drive circuit 17 comprises a variable resistor 21 for adjusting the moving speed of the working table 4, a waveform generator 22 for generating signal waveforms depending on the sizes of resistance values, a comparator 24 for comparing signals generated in the first LVDT circuit 13 with one another, a trigger 25 for outputting pulse signals to start the operation of other circuits, a reverse counter 26 for outputting digital signals to increase or decrease the pulse signals, a signal generating ROM 27 in which predetermined memory logic is input, a digital-to-analog converter 28 for converting digital signals to analog signals, and a variable resistor 29 for adjusting the width of the reciprocation of the working table 4. As shown in FIG. 5, the load drive circuit 18 comprises a variable resistor 30 for determining the value of the applied load of the second drive means depending on signals output from the second LVDT circuit 14 and a feedback circuit 31 for keeping the applied load constant during tests.

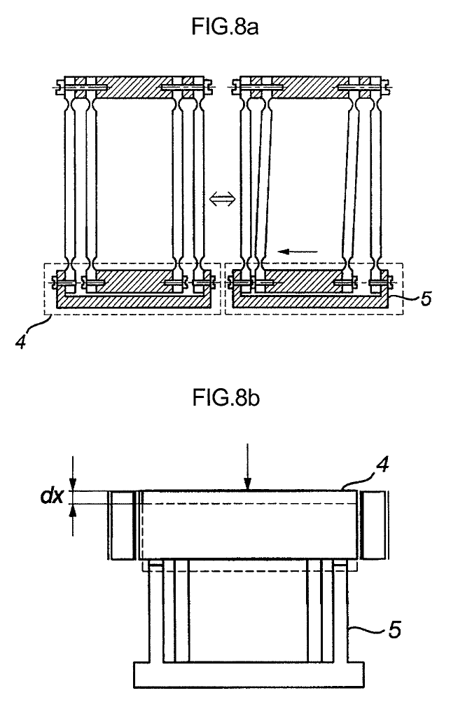

The first drive means comprises a step motor 3a, a lead screw 3b connected to and rotated together with the step motor 3a, and an operating member connecting the lead screw 3b and the working table 4 to convert the rotating movement of the lead screw 3b to linear reciprocating movement and transmit it to the working table 4. As shown in FIGS. 8a and 8b, the working table 4 is supported by a guide 5 having horizontal resilience so as to allow the working table 4 to be horizontally reciprocated in a predetermined distance and prevent the working table 4 from being vertically moved. The guide 5 is constructed by attaching an inner guide and an outer guide to each other, with the inner guide attached to the lower surface of the working table 4 and the outer guide attached to the floor plate of the testing apparatus.

The second drive means comprises a loading plate 7a situated under the lower surface of the working table 6 to vertically move the roundly tipped specimen 2 by magnetic force, an electromagnet 7b for exerting magnetic force on the loading plate 7a when current is applied to the electromagnet 7b, a counter weight 7c for keeping the load of the support arm 6 constant when current is not applied to the electromagnet 7b, and an adjusting bolt 7d situated on the top of the support arm 6 to adjust the vertical position of the support arm 6. As indicated in FIG. 6, the roundly tipped specimen 2 is secured to a resilient member 32 that is attached to the lower surface of the support arm 6 and has predetermined resilient force.

Hereinafter, the operation of the apparatus for testing the friction and wear characteristics of minute parts is described.

The working table 4 is reciprocated in a predetermined distance by the operation of the step motor 3a. The moving distance of the working table 4 is adjusted to a relatively small extent by the combined action of the lead screw 3b (which is connected to the step motor 3a) and the operating member 3c, so the slide distance can be adjusted to 0.08 μm. As a result, the apparatus has a high precision and a lower operation noise.

The testing apparatus of the present invention should generate minute displacements and be stably operated for a long time, so “a step motor control system” disclosed in Korean Patent Appln No. 10-1999-16708 and invented by the same inventors as those of the present invention, which is capable of precisely controlling positions of a testing apparatus and stably operating the testing apparatus while supporting a predetermined load, is employed in the testing apparatus of the present invention.

Referring to FIG. 1, in accordance with the step motor control system, while the working table 4 is reciprocated at a predetermined velocity by the step motor 3a, the moving velocity of the working table 4 is adjusted by the variable resistors R1 and R2. The size of resistance value is dependent upon the clock frequency of the signal waveform generated by the waveform generator 22. The first sensor 8 senses the position of the working table 4 using induced electromotive force generated by variations in the position of the working table 4, and outputs the signal having a value in proportion to each position value. An output signal is input to the first LVDT circuit 13, and generates an UP/DOWN signal waveform that determines the moving direction of the working table 4. In the reverse counter 26, the UP/DOWN signal waveform output from the trigger 25 is compared with the clock frequency input from the waveform generator 22. Accordingly, two sine wave type signals having a phase difference of 90° are generated by an input digital signal input from the reverse counter 26, amplified and supplied to the winding of the step motor 3a, thereby operating the step motor 3a. Meanwhile, the size of reciprocating stroke can be adjusted by the variable resistors R2 and 29.

In the step motor control system, a pulse signal adjusting method for controlling the winding excitation force of a step motor is employed in combination with a method for allowing the movement of a rotator to be constant by adjusting the value of current supplied to a winding, so a step motor can be operated precisely. The step motor can be operated continuously, so the slide distance can be controlled finely and can be kept constant. Additionally, the step motor control system can minimize the heat generated by the step motor, so the step motor control system is suitable for the friction and wear testing apparatus that should be operated for a long time. During the reciprocating movement, the position of the working table 4 is sensed by the first sensor 8, and the movement of the working table 4 is controlled to be reciprocated within a predetermined reciprocating range.

The control unit 200 measures four data, that is, the position of the plate specimen 1, an applied load, frictional force and the position of the roundly tipped specimen sensed by the first, second, third and fourth sensors, generates an analog signal corresponding to the data, and processes the signal by a computer 19, thereby studying the friction and wear characteristics of a minute part in real time.

The friction coefficient of the friction portion can be calculated using measured applied load and the value of frictional force, and the friction characteristics between the materials of specimens can be studied by investigating variations in the friction coefficient during a test. The wear depth of the plate specimen 1 can be found using the position values of the plate and roundly tipped specimens 1 and 2, so the friction and wear characteristics of a minute part having relatively small relative displacement and applied load can be easily found.

Referring to FIG. 5, in load control and measure means, the loading plate 7a for applying a load to a friction portion is balanced by the counter weight 7c in a normal state. When current is applied to the electromagnet 7b, the loading plate 7b is deflected in proportion to generated magnetic force to push the friction portion, thereby exerting a load upon the friction portion. In this case, the size of the generated magnetic force can be changed by controlling the size of voltage applied to the electromagnet 7b, so the load (hereinafter, referred to as “applied load”) exerted on the friction portion can be continuously and precisely adjusted, thereby achieving a low load exerted on the testing apparatus within a certain range.

The size of an applied load can be found by measuring the deflection amount of the loading plate 7a using a closed control system comprised of the second sensor 8 and the second LVDT circuit 14. The variable resistors R3 and 30 are used to determine the value of an applied load, and the applied load can be kept constant by a control method using a feedback circuit 31 during a test, regardless of variations in length between the loading plate 7a and the electromagnet 7b.

Referring to FIG. 6, the frictional force generated on the friction portion of the specimen can be measured by measuring the instantaneous displacement of a measuring plate 33 connected to a roundly tipped specimen mount 34 supported by the resilient member 32 by the third sensor 10. When the spring coefficient and instantaneous displacement of the measuring plate 33 are referred to as k and x, the frictional force F is kx.

In general, the frictional force measuring device of the friction and wear testing apparatus is placed on the working table 4. In this case, the following problems may occur. First, the movement of a working table on which a testing apparatus is mounted affects a measuring sensor. Second, a measuring device is affected by variations in dynamic characteristics by the weight of a specimen, so a measurement error may occur. However, in the friction and wear testing apparatus of the present invention, a measuring sensor is designed to be independent of the movement of the specimen, so a cause of measurement errors is eliminated. Additionally, a plate type structure is employed, so there is eliminated a problem in which a load affects variations in the position of the measuring unit, thereby considerably increasing measuring accuracy.

The third sensor 10 is connected to the third LVDT circuit 15 and outputs an analog signal corresponding to frictional force. When the signal is processed by the computer having an analog-to-digital converter, variations in frictional force can be observed during a test.

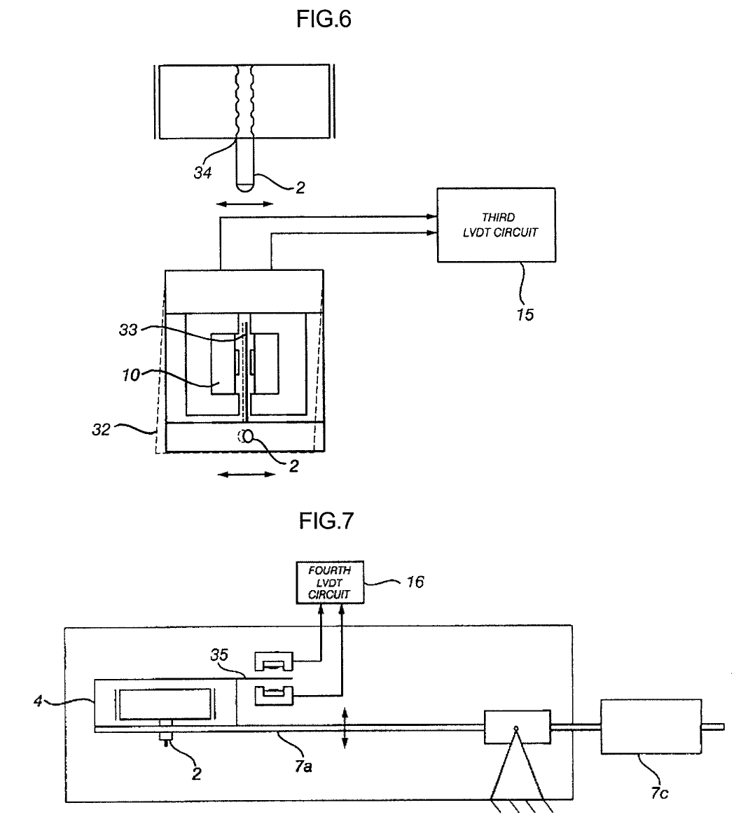

Referring to FIG. 7, in measuring the shape of a friction portion, during a test, the roundly tipped specimen 2 is reciprocated while being in contact with the plate specimen 1, so variations in the shape of the friction portion can be observed in real time when the movement of the roundly tipped specimen 2 is traced by the fourth sensor 11 that senses variations in the position of the measuring plate 35 connected to the loading plate 7a. A signal generated in the fourth sensor 11 is input to the LVDT circuit 17, and variations in the shape of the friction portion can be observed using the computer 19 having an analog-to-digital converter, the same as in measuring frictional force.

As a result, the testing apparatus provides convenience to a user by the real-time observation of a wear state, allows a user to precisely measure related values by the prevention of measurement errors, and there can be observed the state of a friction portion in a narrow space not accessible to an additional instrument.

The guide 5 is secured to the lower plate 12 of the fine friction and wear testing apparatus and connected to the working table 4 so as to guide and support the working table 4. The guide 5 constructed as described above has the following advantages.

First, the guide does not create noise and friction, and does not create a stick-slip phenomenon despite prolonged use. Second, the guide can be used in various speed ranges in comparison with a bearing guide. Third, the displacements of the working table can be precisely measured because an unnecessary displacement dx is not created by an applied load in the direction perpendicular to the moving direction of the working table when the support is made in the form of a symmetrical structure.

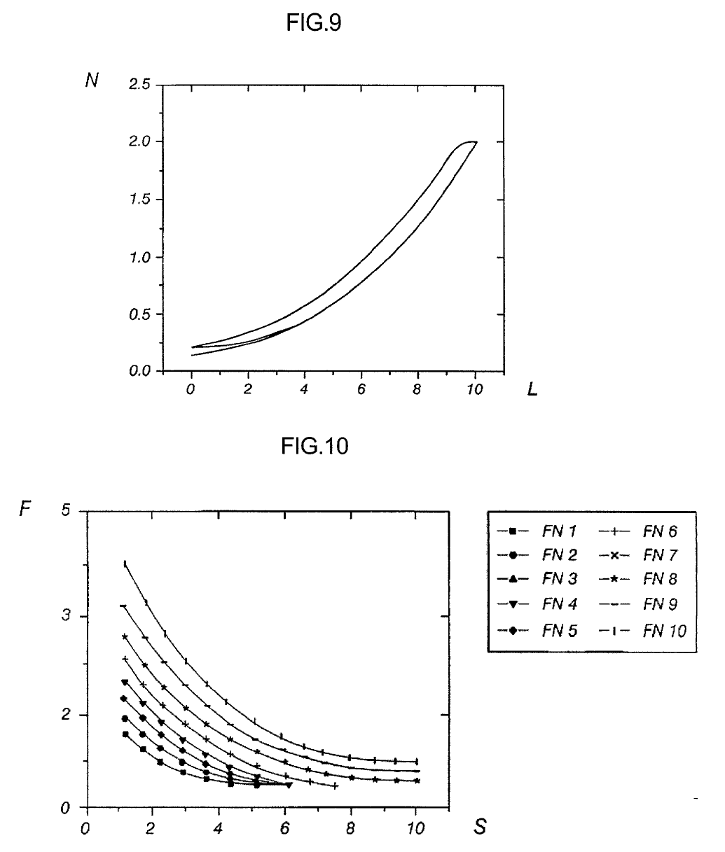

FIG. 9 is a graph showing the load characteristics of the fine friction and wear testing apparatus of the present invention. In this graph, forces N exerted on a specimen are measured while the load number L of the control unit is varied. As indicated in the graph, a load can be continuously controlled in a range of 0.03 to 2.0 N, and a load adjustment resolution is 0.0005 N.

FIG. 10 is a graph showing the frequency characteristic of the first drive means of the fine friction and wear testing apparatus in accordance with the present invention. In this graph, the periods F of the reciprocating movement of the working table are measured while the stroke number S and frequency number FN of the first drive means are varied. The graph shows that the fine friction and wear testing apparatus of the present invention has an easily adjustable characteristic for achieving an arbitrary frequency number.

In the fine friction and wear testing apparatus of the present invention, the step motor for reciprocating the working table on which the plate specimen is placed and the electromagnet for exerting a load on the friction portion of the plate specimen using magnetic force generated by current applied to a winding are controlled by the computer. The maximum design load is 2 N, the maximum reciprocating stroke is 8 mm and the maximum frequency is 3 Hz, and the resolution of load and reciprocating stroke can be precisely controlled to be less than 0.1 gm and 0.005 N.

As a result, in accordance with the fine friction and wear testing apparatus of the present invention, a slide distance can be finely controlled, the size of the applied load and the frequency can be continuously controlled, variations in the shape of the friction portion can be observed in real time, the testing apparatus can be operated for a long time, and reliable test results can be obtained.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A fine friction and wear testing apparatus, comprising:
a working table to whose upper surface a plate specimen is secured;
first drive means for horizontally reciprocating said working table;
a support arm situated over said working table for securely holding a roundly tipped specimen to be projected downwardly;
first sensing means for sensing the horizontal displacement of said plate specimen;
second drive means for operating said support arm to exert a load on said plate specimen through said roundly tipped specimen;
second sensing means for sensing the displacement of said roundly tipped specimen;
a control unit for operating said first and second drive means in accordance with set values and calculating the displacements sensed by said first and second sensing means; and
a display for showing the friction and wear characteristics of the specimens to users in real time.

2. The apparatus according to claim 1, wherein said control unit comprises linear variable differential transformer circuits for generating signals corresponding to displacements sensed by said sensing means and calculating means for calculating test values using signals output from said linear variable differential transformer circuits and transmitting operation signals corresponding the test values to said first and second drive means.

3. The apparatus according to claim 1, wherein said second sensing means consists of a sensor for sensing an applied load between said specimens, a sensor for sensing the horizontal displacement of said roundly tipped specimen and a sensor for sensing the vertical displacement of said roundly tipped specimen.

4. The apparatus according to claim 1 or 3, wherein said sensing means is an induced electromotive force sensor.

5. The apparatus according to claim 2, wherein said calculating means includes an analog-to-digital converter for converting signals output from said linear variable differential transformer circuits to digital signals.

6. The apparatus according to claim 1, wherein said control unit comprises a variable resistor for determining the value of the applied load of the second drive means depending on signals output from the linear variable differential circuit and a feedback circuit for keeping the applied load constant during a test.

7. The apparatus according to claim 1, wherein said first drive means comprises a step motor, a lead screw connected to and rotated together with said step motor, and an operating member connecting said lead screw and said working table to convert the rotating movement of said lead screw to linear reciprocating movement and transmit it to said working table.

8. The apparatus according to claim 1, wherein said working table is supported by a guide having horizontal resilience so as to allow the working table to be horizontally reciprocated and prevent the working table from being vertically moved.

9. The apparatus according to claim 8, wherein said guide is constructed by attaching an inner guide and an outer guide to each other, with the inner guide attached to the lower surface of the working table and the outer guide attached to the floor plate of the testing apparatus.

10. The apparatus according to claim 1, wherein said second drive means comprises a loading plate situated under the lower surface of the working table to vertically move the roundly tipped specimen by magnetic force, an electromagnet for exerting magnetic force on the loading plate when current is applied to the electromagnet, a counter weight for keeping the load of the support arm constant when current is not applied to the electromagnet, and an adjusting bolt situated on the top of the support arm to adjust the vertical position of the support arm.

11. The apparatus according to claim 10, wherein said roundly tipped specimen is attached to the lower surface of said support arm and is secured to a resilient member.
